(19) United States
(12) Patent Application Publication
(10) Pub. No.: US 2006/0069174 A1
(43) Pub. Date: Mar. 30, 2006

(54) Flame resistant polyurethane materials containing melamine-derived additives

(76) Inventors: Philip T. Radford, Roebuck, SC (US); Jusong Xia, Moore, SC (US)

Correspondence Address: Terry T. Moyer, P. O. Box 1927, Spartanburg, SC, 29304, US

(21) Appl. No.: 10/950,733

(22) Filed: Sep. 27, 2004

(51) Int. Cl. C08G 18/00

(52) U.S. Cl. 521/155

(57) ABSTRACT

Polyurethane foam is disclosed having improved flame retardancy, charring, and intumescent properties. The foam is prepared from a reaction mixture comprising at least one isocyanate or diisocyanate, one blowing agent, one surfactant, one catalyst, and one reactive hydroxyl-terminated oligomeric liquid melamine derivative. The resulting foam provides substantial resistance to burning. A melamine-derived compound having at least alkyl or alkoxy groups, with hydroxy (—OH) termination(s) have proved to be particularly useful in connection with polyurethane foam.

### BACKGROUND OF THE INVENTION

Melamine and derivatives of melamine have been used for many years in polyurethane foams for decreasing the propensity of such foams to burn. Polyurethane foams are used in a wide variety of consumer products. Relatively strict regulatory and safety guidelines govern the level of flame retardancy that must be exhibited by such materials. Without flame retardant additives, polyurethane foams readily burn.

Melamine (cyanurtriamide; 2,4,6-triamino s-triazine, CAS nr. 108-78-1) is a solid white crystalline powder with a melting point of approximately 354° C. and a density of about 1.573 grams/cc (see molecular structure below). At greater than 200° C., melamine vaporizes or sublimes, which dilutes the fuel gases and oxygen near the combustion source. This is one mechanism by which melamine acts to control flammability of materials to which it is added.

After being dispersed in foam, for example, melamine is capable of absorbing heat, which assists in retarding fire.

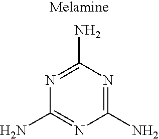

Upon decomposition, melamine absorbs heat equal to about 470 kcal/mole. This endothermic process acts as a heat sink to a fire. Melamine inhibits the spread of the fire using several different flame retardant mechanisms. Melamine may act as a non-combustible heat sink that absorbs the energy of combustion reducing the temperature of the reaction. Melamine acts to form a noncombustible “char” upon the surface of the polymer that sometimes prevents the further spread of flame. Melamine may sublimate as the char is being formed to create an intumescent barrier.

It is important to note that melamine is a solid at ambient (room) temperature. Solid materials sometimes are difficult to use in manufacturing environments that use liquids, as solids require adequate dispersion in the liquid components. The necessity of dispersing solid materials can create large energy and cost demands in a manufacturing processes. Energy and time is required to disperse solids homogenously in a liquid resin. Solids sometimes agglomerate, and the additive containing part may lose effectiveness due to the additive not being homogenously mixed in the polymer. For these reasons inventors have sought to disperse melamine.

One approach used in the prior art is to incorporate dispersing additives, into a polyol to help keep solid melamine dispersed in solution. U.S. Pat. No. 4,293,657 to Nissen et. al (BASF) shows one such procedure. This references teaches the use of melamine-polyoxyalkylene polyether polyol dispersions of melamine particles. It is very important when making such dispersion that the melamine be effectively dispersed into the polymer.

One problem with melamine that is not adequately dispersed into a polyol is that the melamine may undesirably leach or sublime out of the foam product. In some applications this could result in undesirable fogging of interior surfaces as, for example foam applications in automobiles interiors. In general, it is an undesirable consequence of applying materials into foams that are extractable and may sublime out of the foam. This is due in part to the relatively large amount of air/foam interface that is present in foam. Thus, dispersing solid melamine materials in foam presents a significant challenge.

Solids naturally settle out of urethane starting materials. Mixing these solids has the undesirable effect of whipping air into the liquid. Although air can be removed with vacuum technology, it is an expensive process and very inconvenient during polyurethane foam production. In addition, during the vacuum process the solid materials begin to settle.

Most existing commercial flame retardant systems for polyurethane foams contain halogens. Recently, regulatory pressures have made it more difficult for manufacturers to use halogenated flame retardant compositions. For environmental and regulatory reasons, it is highly desirable to avoid the use of halogens.

Various methods have been employed to more effectively disperse solid melamine into polymeric materials. For example, an anionic dispersant is shown and described in U.S. Pat. No. 5,741,827 to Chakrabarti et. al.

Another approach that has been used is to chemically modify a polyol so that melamine is more easily dispersed, as in U.S. Pat. No. 5,536,757 to Walmsley. The disclosure of this patent proposes to use melamine with a polyol to improve dispersibility of the melamine in the foam product.

U.S. Pat. No. 4,225,645 discloses a melamine-derived additive which provides beneficial effects on the drip burn rate of polyurethane foams formed using hexaalkoxymethyl melamines as foam additives. The additive employs —(CH₂O—R)₂ groups on the melamine derived structure, wherein R is stated to be a C₁-C₅ straight or branched chain alkyl group. The material has no repeating monomer which could lead to a repeating chemical unit. This fact means that the material claimed is not polymeric in nature.

U.S. Pat. No. 4,317,889 employs melamine-derived additives to promote the intumescence of the polyether foam upon burning.

More effective methods and compositions are needed for providing reliable flame retardancy in foamed materials, such as polyurethane. In particular, additives that more readily disperse in liquid foam precursor materials would be desirable. Furthermore, additives that avoid the use of halogens would be desirable. An additive that actually covalently binds itself to the polyurethane polymer, thereby avoiding simple dispersions that undergo undesirable leaching or sublimation would be highly desirable.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 1 is an illustration of a melamine-derived moiety reacted in a polyurethane foam; and

FIG. 2 shows test data results for Burn and Drip Burn testing of at least one foamed composition of the invention which employs the inventive melamine derived components, as compared to known controls.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

### Foam Manufacture

Flexible, resilient, polyurethane foam is used for a wide variety of applications. The foam formed in the practice of the invention provides improved flame resistance, and intumescent properties. The foam may be prepared from a reaction mixture comprising an organic polyisocyanate, a blowing agent, a polyol, a surfactant, one or more catalysts, and a reactive hydroxyl-terminated liquid melamine derivative, as further described herein. The resulting foam provides substantial resistance to burning.

In general, polyurethane foam is produced through the catalyzed polymerization of the reaction products of polyols and isocyanates. Such a reaction is well known throughout the polyurethane industry and has been practiced for many years. The potential number and types of polyols utilized within this invention are plentiful. Such a compound is defined as comprising at least two alcohol moieties, preferably at least three. The free hydroxyl groups react well with the isocyanates to form the urethane components which are then polymerized to form the desired polyurethanes. Blowing agents present within the polymerization step provide the necessary foam-making capability. One preferred polyol is a typical tri-functional 3000 MW polyol, Arcol F-3022 polyol, available from Bayer.

Isocyanates and diisocyanates, are well known components of such polyurethane foams and include any compounds which possess at least one free cyanate reactive group, and often at least two, although more may be utilized. Such compounds may also be aliphatic or aromatic in nature. The most prominently utilized isocyanates, and thus the most preferred types for this invention, are toluene diisocyanate and methylene diisocyanate. The polyol is generally reacted with a slight excess of isocyanate (ratio of from 1:1.04 to 1:1.12) to produce a soft foam product; the greater the ratio, the harder the produced foam). In practice, two separate streams of liquids (one of polyol, the other of isocyanate) are mixed together in the presence of one or more polymerization/gellation catalysts or combination of catalysts and a blowing agent in order to produce the desired polyurethane foam product.

The catalysts employed may be any type that effectuates the polymerization of the isocyanate/polyol reactants noted above to form the desired polyurethane in foam form. The term “tertiary amine-based hydroxy-containing catalyst” is intended to encompass any gelation/blowing catalyst utilized within polyurethane production which comprises at least one amine constituent. As noted above, amine-based catalysts, and more specifically, tertiary amine catalysts, are widely utilized within such specific foam-producing methods. Two catalysts, in particular, DABCO TL, and DMEA, are excellent gelation/blowing catalysts for this purpose; however, they also appear to be extremely reactive with and readily attack unmatched electrons on nitrogen-containing moieties. As noted above, oxidation by the amine readily occurs upon exposure to high temperatures, thus resulting in undesirable scorched foam portions. In addition these catalysts

Although any amine presents such a potential reactivity (oxidation) problem, and thus is contemplated within the scope of this invention, it has been found that the highly reactive tertiary amines present greater threats to discoloration and degradation to the final foam product. The amount of tertiary amine hydroxy-containing catalyst required to effectuate the desired urethane polymerization is low, from between 0.05 php to about 2.00 php (php indicating parts per hundred of the polyol content within the foam-making composition); more specifically, such a range is from about 0.07 php to about 0.60 php. Even though the number of free amines available are quite low, their ability to deleteriously affect the final foam product through oxidation of free reactive groups (hydroxyls, for example) within colorants, polyols, and other additives, is pronounced upon exposure to high temperature during polymerization.

Other additives or solvents may also be present within the foam-making composition. Auxiliary blowing agents are required to provide the necessary foam blowing capability and reduce chances of combustion. Such compounds include methylene chloride, acetone, carbon dioxide (which may be liberated during the reaction between water and isocyanate), and the like, and are present in amounts of between about 1.0 php and 10 php of the entire foam-making composition. Water may thus also be added in relatively low amount (i.e., from about 1 to about 10 php; most preferably between about 3 and 7 php) to provide carbon dioxide for blowing purposes. Silicones may be added to provide desired cell structure and foam stability and are present in an amount from about 0.1 to about 2 php of the entire foam-making composition; preferably from about 0.9 to about 1.6 php.

### Melamine-Derived Additives

Many melamine-derived components may be used in the practice of the invention. The greatest success has resulted from melamine-derived components that are liquid at room (ambient) temperatures, thereby facilitating the homogenous mixing into a polyol starting material and hence into a polyurethane foam.

It has been found that a melamine-derived additive having the structure as shown below may be advantageously used in foams: 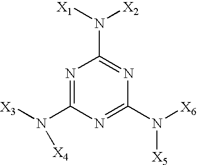
wherein X₁-X₆ each are independently selected from the group consisting of H and oligomeric oxyalkylene chain represented below 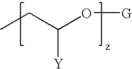
wherein

Y is selected from the group consisting of H and CH₃; and

z is comprised positive integers or fractional numbers between 1 and 20; and

G is H, or an oligomeric ester radical represented as the following structure 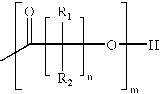
wherein:

R₁ and R₂ each are independently selected from H or C₁-C₁₀ alkyl groups;

n comprises an integer between 1 and 10;

m comprises any positive integer or fraction between 0 and 20;

and wherein at least one of said X₁-X₆ groups is —OH terminated.

Furthermore, a melamine derivative is provided in one aspect of the invention wherein X₁-X₆ each are independently selected from the group consisting of H and oligomeric oxyalkylene chain represented as
-(EO)ₐ(PO)_{b}(EO)_{c}-G
wherein

G is as defined above;

EO comprises ethylene oxide or a derivative thereof; and

PO comprises propylene oxide or a derivative thereof; and
a, b and c comprise positive integers or fractional numbers between 0 and 20, and further wherein a+b+c is equal to or greater than 1.

In other embodiments, at least one of X₁-X₆ is selected from the carbon/oxygen chain group shown above; while the others of said X₁-X₆ groups typically comprise H. A common moiety for at least one of X₁-X₆ is a ethylene oxide (EO) or propylene oxide (PO) group, or both.

In some cases, one, two, three or more X₁-X₆ groups may comprise alkyl, alkoxy, or other carbon-containing groups, within the same general structure shown above. There is no practical limit to the number of possibilities that may be employed, however, it is noted that each of the X₁-X₆ groups usually will contain at least one hydroxyl (—OH) terminated moiety.

The melamine-derived component comprises one or more “EO” groups in positions corresponding to X₁-X₆ which may be in sequence, or attached to each other. A melamine-derived component with substituted components that result in a melting point below ambient (room) temperatures is preferred, as liquid components mix into manufacturing processes much more uniformly and evenly.

It is believed that the employment of a terminal hydroxyl group (—OH) on at least one of said X₁-X₆ is useful in facilitating the reaction of the melamine-derived component covalently into the polymer. During the process of foam manufacture, isocyanate groups (—NCO) react with the terminal hydroxyls (—OH) of the said Melamine derivatives such that a urethane linkage is formed between the additive and the polyurethane. The said Melamine derivative becomes an integral part of the polyurethane matrix. Thus, it is believed that the said Melamine derivative is not physically trapped in the polyurethane as a particulate/contaminant but covalently bound into the polymer.

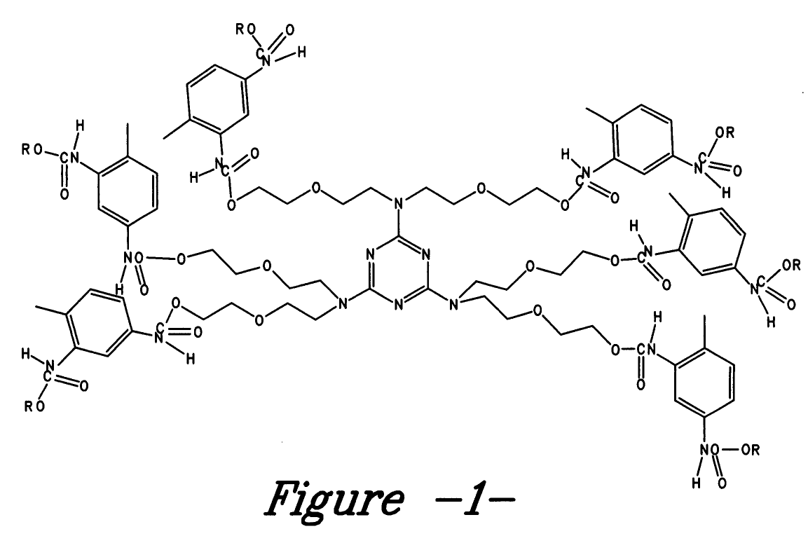

Reaction of such a melamine-derived structure into polyurethane material is further described below in connection with Example 2, and also is shown schematically in FIG. 1. Within the said melamine derivative, one, or more, or all, of said X₁-X₆ groups may be hydroxy (—OH) terminated.

### EXAMPLE 1

### Control (No Flame Retardant Additive)

A standard polyurethane foam article was first produced to investigate the results of light, gas, and thermal exposures in terms of any discolorations, yellowings, and/or other types of degradations. Such foam was produced through the reaction of the following components, shown in Table 1 below.

TABLE 1
Components Employed in Making Polyurethane Foam

| | | Foam Formulations | | | | | | |
|---|---|---|---|---|---|---|---|---|
| | | Loading | Polyol | TDI | Niax L- | DABCO | Water | T-10 |
| Example | Sample | (php) | (parts) | (php) | 620 (php) | 33LV (php) | (php) | (php) |
| 1 | Control | n/a | 100 | 43.6 | 1.00 | 0.15 | 4.53 | 0.30 |
| 2 | Melamine | 10 | 100 | 43.6 | 1.00 | 0.15 | 4.53 | 0.30 |
| 3 | Melamine 12 EO | 10 | 100 | 43.6 | 2.00 | 0.00 | 4.53 | 0.03 |
| 4 | Melamine 3 EO | 10 | 100 | 43.6 | 2.00 | 0.00 | 4.53 | 0.03 |
| 5 | Melamine 6 EO | 10 | 100 | 43.6 | 2.00 | 0.00 | 4.53 | 0.03 |
| 6 | Melamine 24 EO | 10 | 100 | 43.6 | 2.00 | 0.00 | 4.53 | 0.03 |
| 7 | Melamine 36 EO | 10 | 100 | 43.6 | 2.00 | 0.00 | 1.00 | 0.03 |
| 8 | Melamine 12 EO/10 PO | 10 | 100 | 43.6 | 2.00 | 0.00 | 4.53 | 0.03 |

Upon mixture within a reaction vessel, the reaction created a “health” bubble (indicating gelation and blowing balance), and the vessel was then exposed to 160° C. (generated within a conventional oven to simulate actual heat history encountered on an industrial production level) for about 3 minutes allowing the material to cure. The resultant foam bun was then sliced in half and analyzed empirically for Flame Retardant stability.

### EXAMPLE 2

### Second Control: Melamine in a Polyurethane Foam

Polyurethane foam was prepared as in Example 1 above, except that melamine (shown below) was added into the foam as a flame retardant additive. The melamine was added in a concentration of 10 php (parts per hundred polyol. A health bubble was observed in this formulation.

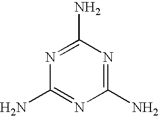

### EXAMPLE 3

### One Embodiment of the Invention: 12-EO Melamine

A melamine derived compound having a total of 12 ethoxylate groups attached on the X₁-X₆ attachment positions (i.e. known as “12-EO melamine”) was synthesized. The synthesis of the melamine derivative is described below:

To a 2 liter 3-neck flask were charged with 76.8 g of Melamine, 633.6 g of ethylene carbonate and 0.9 g of K₂CO₃. The mixture was heated to 160C for 4-6 hours while stirring, or until no more gas bubbles was generated. Upon cooling down to room temperature, 389.9 g of product Melamine 12EO was synthesized as a yellow liquid.

Melamine 12EO is also referred as “12EO Melamine” in this invention, which comprises the structure shown below: 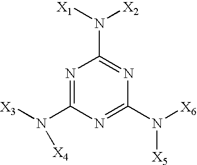
wherein X₁ -X₆ each are independently selected from the group consisting of H and oligomeric oxyalkylene chain such that the total number of ethoxylated units is 12.

Once synthesized, Melamine 12 EO was used as flame retardant to prepare polyurethane foam, as further described here: Ten grams of 12 EO Melamine material was included into the mixture of components described in Table 1 (with variation in the level of material as denoted) and the procedure for producing foam listed in Example 1 was followed.

### EXAMPLE 4-7

Other melamine derived compounds were synthesized according to the procedure in Example 3, but with reduced or increased charges of ethylene carbonate so as to create molecules with an average of between 3 ethylene oxide units for example 4 to 36 ethylene oxide units for Example 7. The average number of ethylene oxide units referring here is in relation to a single melamine moiety.

### EXAMPLE 8

Another melamine derived compound was synthesized according to the procedure in Example 3, but with the subsequent exposure of the material to propylene oxide using a low pressure reactor such that a single melamine molecule had a average distribution of 12 ethylene oxide units and 10 propylene oxide units.

### Performance Testing

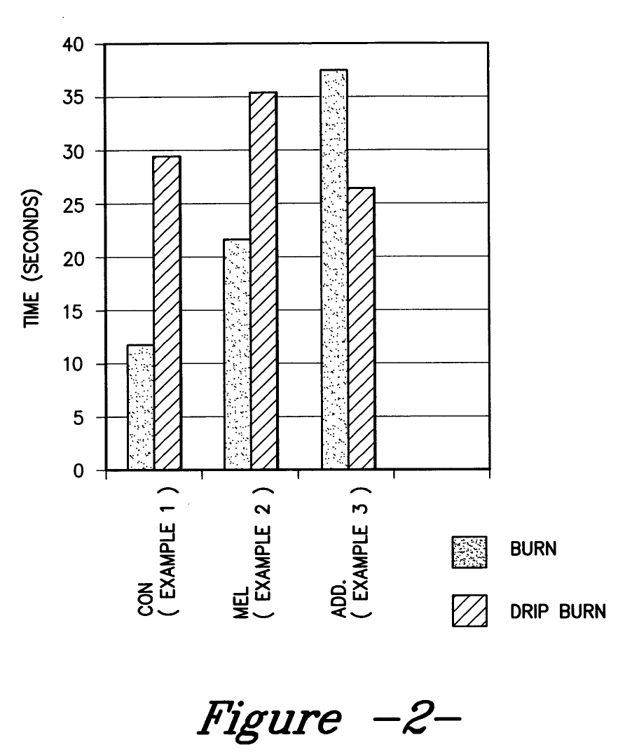

Testing of the foams formed in Examples 1-3 was performed. A control (as in Example 1) without flame retardant was compared against a polyurethane foam using only melamine flame retardant (Example 2), and one particular composition of the invention (12 EO Melamine, Example 3). Results are shown in FIG. 2, wherein “Con” references Example 1 results, and the “Mel” references Example 2 results, and “Add” represents the results for the foam made according to Example 3.

Testing was conducted for Burn, and for Drip Burn, according to ASTM Standard D 6413-99.

TABLE 2
Flame Retarding Performance Test Results

| | | Performance | | | | | |
|---|---|---|---|---|---|---|---|
| | | | Loading | Self | % Char | Foam burn | Drip burn |
| Example | Sample | % N | (php) | extinguish? | remain | (sec) | (sec) |
| 1 | Control | 0 | n/a | No | 0.0 | 12.0 | 30.0 |
| 2 | Melamine | 67.7 | 10 | No | 0.0 | 22.0 | 36 |
| 3 | Melamine 12 EO | 12.8 | 10 | No | 0.0 | 36.0 | 27.0 |
| 4 | Melamine 3 EO | 32.5 | 10 | Yes | 94.4 | — | 4.0 |
| 5 | Melamine 6 EO | 21.5 | 10 | Yes | 92.8 | — | 4.0 |
| 6 | Melamine 24 EO | 7.1 | 10 | No | 0.0 | 80.0 | 30.0 |
| 7 | Melamine 36 EO | 4.9 | 10 | No | 0.0 | 30.0 | 35.0 |
| 8 | Melamine 12 EO/10 PO | 6.8 | 10 | Yes | 80.0 | — | 8.0 |

The results suggested unexpectedly superior characteristics for the inventive composition of Example 3-8 compared to the controls (Examples 1 and 2). In particular, it required a longer period of time for the sample to burn using the foam reacted with the 12 EO Melamine Foam, as compared to the controls. Furthermore, the Drip Burn time for the 12 EO Melamine Foam was less than the control, indicating that the drip burn characteristics for the 12 EO Melamine Treated Foam were superior. The data represents unexpected and surprisingly good results. In some instance (examples 4, 5 and 8) the foam was self-extinguishing meaning upon removal of the ignition source the flame did not propagate up the sample foam. In these cases the % char length is recorded for the samples.

It is important to note that the nitrogen concentration is reduced with increasing amounts of ethoxylation or propoxylation. All of the derivatives function better than melamine alone. The fact that a melamine derivative with less nitrogen concentration functions as a better flame retardant as opposed to melamine alone is unobvious and unexpected.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A flame retarding polyurethane foam made by combining at least the following, in the presence of a catalyst:
(a) at least one isocyanate or diisocyanate,
(b) a polyol, and
(c) a liquid melamine-derived component, said melamine-derived component having the structure: 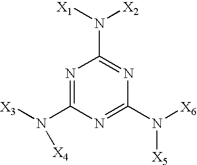
wherein X₁-X₆ each are independently selected from the group consisting of: H and oligomeric oxyalkylene chain represented below 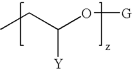
wherein
Y is selected from the group consisting of H and CH₃; and
z is comprised positive integers or fractional numbers between 1 and 20; and
G comprises: H or an oligomeric ester radical; and
wherein at least one of said X₁-X₆ groups is —OH terminated.

2. The flame retardant foam of claim 1 wherein said X₁-X₆ comprise said oligomeric oxyalkylene chain, and further wherein said oligomeric oxyalkylene chain comprises:
-(EO)ₐ(PO)_{b}(EO)_{c}-G
wherein
G comprises H or an oligomeric ester radical; and
EO comprises ethylene oxide or a derivative thereof; and
PO comprises propylene oxide or a derivative thereof; and
a, b and c comprise independently selected positive integers or fractional numbers between 0 and 20, and
further wherein a+b+c is equal to or greater than 1.

3. The flame retardant foam of claim 1 wherein G comprises an oligomeric radical ester: 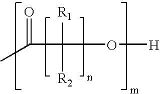
wherein:
R₁ and R₂ each are independently selected from H or C₁-C₁₀ alkyl groups;
n comprises an integer between 1 and 10;
m comprises any positive integer or fraction between 0 and 20.

4. The flame retardant foam of claim 2 wherein at least one of said X₁-X₆ groups includes a hydroxy terminated EO group.

5. The flame retardant foam of claim 2 wherein at least one of said X₁-X₆ includes a hydroxy terminated PO group.

6. The flame retardant foam of claim 1 wherein Y comprises H.

7. The flame retardant foam of claim 1 wherein X₁-X₆ comprise said oligomeric oxyalkylene chain, and further wherein z is 2.

8. The flame retardant foam of claim 2 wherein at least one of X₁-X₆ comprises a hydroxy terminated EO or PO group.

9. The flame retardant foam of claim 1 wherein said 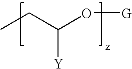
comprises an alkyl group or an alkoxy group.

10. The flame retardant foam of claim 9 wherein said alkoxy group comprises a moiety having a chain, said chain comprising: at least one —O— and at least two —C— atoms.

11. A flame retarding polyurethane foam made by combining, in the presence of a catalyst, at least the following:
(a) at least one isocyanate or diisocyanate,
(b) a polyol, and
(c) a liquid melamine-derived component, said melamine-derived component having the structure: 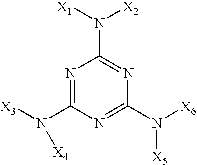
wherein X₁-X₆ each are independently selected from the group consisting of: H, EO groups, and PO groups; and
wherein at least one of said X₁-X₆ groups is —OH terminated.

12. A liquid melamine-derived compound that is capable bonding covalently in a foam and imparting substantial flame retarding properties to said foam, said melamine-derived compound having the structure: 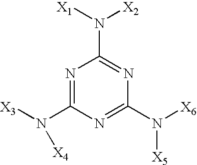
wherein X₁-X₆ each are independently selected from the group consisting of: H, and 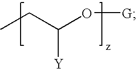
wherein Y is selected from the group consisting of:
hydrogen and CH₃; and
wherein z is between 1 and 10; and
wherein G comprises hydrogen; and
wherein at least one of said X₁-X₆ groups is —OH terminated.

13. The flame retardant foam of claim 12 wherein at least one of said X₁-X₆ groups comprises a hydroxy (—OH) terminated EO group.

14. The flame retardant foam of claim 12 wherein at least one of X₁-X₆ comprises a hydroxy (OH—) terminated PO group.

15. The flame retardant foam of claim 12 wherein Y is hydrogen.

16. The flame retardant foam of claim 12 wherein z is 2.

17. The flame retardant foam of claim 12 wherein at least one of X₁-X₆ comprises a hydroxy-terminated EO or hydroxy-terminated PO group.

18. The flame retardant foam of claim 12 wherein the structure: 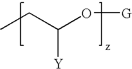
comprises an alkyl or alkoxy group.

19. The flame retardant foam of claim 18 wherein said structure comprises an alkoxy group, said alkoxy group comprising a chain, said chain comprising at least one —O— atom and at least two —C— atoms.

20. A liquid melamine-derived component capable of covalently bonding to an isocyanate or diisocyanate in the formation of polyurethane foam, said liquid melamine-derived composition comprising at least one reactive hydroxyl terminal group.

21. An OH-terminated, liquid, reactive, melamine-derived additive composition that is capable of substantially reducing the burn propensity of polyurethane foam when polymerized with said foam.
